(19) United States
(12) Patent Application Publication
(10) Pub. No.: US 2015/0148719 A1
(43) Pub. Date: May 28, 2015

(54) DEVICE FOR STIMULATING CAPILLARY CONDITIONING

(71) Applicant: Paulo Sergio BERVIAN, Doungguan City (CN)

(72) Inventor: Paulo Sergio BERVIAN, Doungguan City (CN)

(21) Appl. No.: 14/087,664

(22) Filed: Nov. 22, 2013

(51) Int. Cl. A61H 1/00

(52) U.S. Cl. CPC A61H 1/00; A61H 2209/00
USPC 601/49

(57) ABSTRACT

A device for stimulating capillary conditioning by using the force of gravity and exercising the capillary vessel is described, comprising a base with a horizontal area (10) and a vertical projection (20) from the posterior face of said horizontal area (10), where horizontally spaced straps (30) are fastened, said straps (30) are subject to the vibration and movement generated by an engine, and the upper and lower limbs are placed on said straps (30).

### FIELD OF THE INVENTION

The present invention describes a device for stimulating capillary conditioning. More specifically, it comprises a device that allows the upper and lower limbs to be lifted in order to stimulate capillary conditioning and blood circulation through the force of gravity and exercise of capillary vessels.

### BACKGROUND OF THE INVENTION

The exercise of the capillary vessel is based on the theory that the driving force of blood circulation lies in the network of capillary vessels.

There are on average around 5.1 billion capillary vessels in man, of which 3.8 billion are located in the limbs. Around the capillary vessels, there are pericytes that can be stimulated and contracted by exercising the capillary vessels.

When a capillary vessel contracts, blood is sent to a venule, which has valves that do not allow blood to return to the capillaries. In addition to this mechanism, the venules contract rhythmically, sending blood into the heart.

The capillary, when contracted after having sent blood to the venule, in a few seconds enters a vacuum state. When the capillary is contracted, blood flows from an arteriole straight to a venule through the glomus. This is the driving force mechanism behind circulation.

According to Physics, for the capillary phenomenon to occur, three factors are needed: liquid, gaseous and solid. The blood vessel is solid, blood is liquid and vacuum is gaseous. And 60% of the blood volume releases gases when subject to vacuum.

Not only does lifting vertically the upper and lower limbs stimulates circulation through the force of gravity, but also stimulates it by exercising the capillaries.

Thus, the object of the present invention is a device that allows the upper and lower limbs to be lifted and blood to flow by using the force of gravity and by exercising the capillaries through vibration and movement.

### SUMMARY

The invention is characterized by a device for stimulating capillary conditioning that allows the capillary vessels to be excited, to contract and to enlarge.

The invention is characterized by a device for stimulating capillary conditioning that stimulates blood circulation using the force of gravity.

### BRIEF DESCRIPTION OF FIGURES

FIG. 1 illustrates an individual positioned on the device to stimulate capillary conditioning.

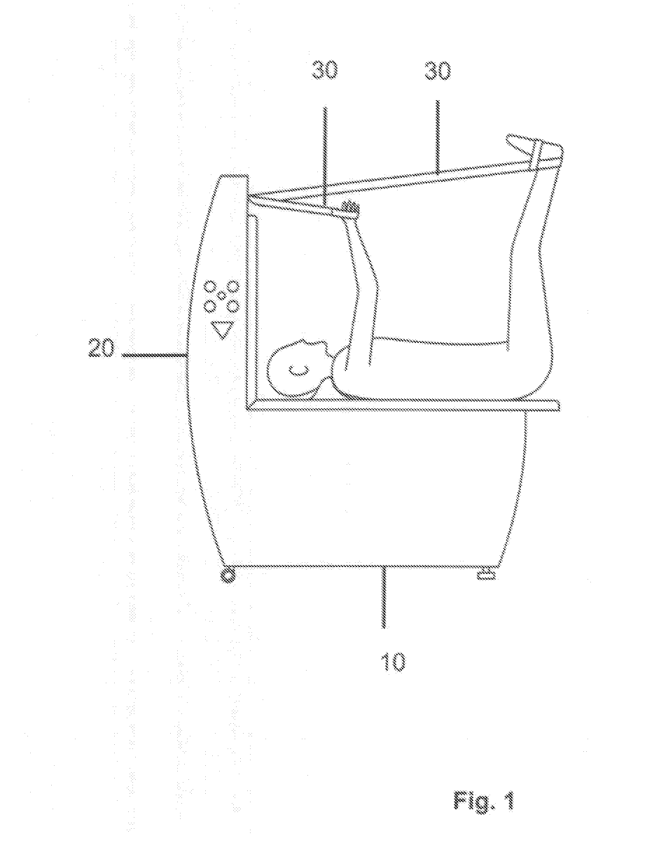

### DETAILED DESCRIPTION OF THE INVENTION

The device for stimulating capillary conditioning, which is the object of the present invention, comprises a base with a horizontal area (10) and a vertical projection (20) from the posterior face of said horizontal area (10).

In the vertical projection (20), straps (30) are fastened and spaced horizontally; said straps (30) are subject to vibration generated by an engine.

The straps (30) have a suitable area for placing the upper and lower limbs of a user.

For the device to work, the user lies down on his back on the horizontal area (10) and

supports the upper and lower limbs on the respective strap (30) so as to position them vertically, parallel to the vertical projection (20) of the device.

The engine is turned on to initiate vibration and move the straps (30).

Optionally, the device can have features for adjusting time and the intensity of vibration and movement.

1. DEVICE FOR STIMULATING CAPILLARY CONDITIONING characterized in that it comprises a base with a horizontal area (10) and a vertical projection (20) from the posterior face of said horizontal area (10) where horizontally spaced straps (30) are located, and said straps (30) are subject to vibration and movement generated by an engine.

2. DEVICE FOR STIMULATING CAPILLARY CONDITIONING, according to claim 1, characterized in that the straps (30) have a suitable area for placing the upper and lower limbs.
